(19) United States
(12) Patent Application Publication
(10) Pub. No.: US 2023/0290272 A1
(43) Pub. Date: Sep. 14, 2023

(54) INSTRUCTION FOR A SIGN LANGUAGE

(71) Applicant: Vika Books, Ltd., London (GB)

(72) Inventor: Victoria Catherine Maude Forrest, London (GB)

(21) Appl. No.: 17/795,128

(22) PCT Filed: Feb. 14, 2020
(86) PCT No.: PCT/GB2020/000015

§ 371 Date: Jul. 25, 2022

(51) Int. Cl. G09B 21/00; G06T 17/00; G06T 19/00; G06F 3/01; G06F 3/0346; G06V 30/19; G06V 20/20

(52) U.S. Cl. CPC G09B 21/009; G06F 3/011; G06F 3/0346; G06T 17/00; G06T 19/006; G06V 20/20; G06V 30/19

(57) ABSTRACT

A system for instruction of a sign language, the system comprising a display device configured to display video depicting an object, and display information relating to a sign language sign associated with the object.

### FIELD OF THE INVENTION

The present invention relates to instruction of a sign language.

### BACKGROUND OF THE INVENTION

Sign languages are used as a nonauditory means of communication between people, for example, between people having impaired hearing. A sign language is typically expressed through ‘signs’ in the form of manual articulations using the hands, where different signs are understood to have different denotations. Many different sign languages are well established and codified, for example, British Sign Language (BSL) and American Sign Language (ASL). Learning of a sign language requires remembering associations between denotations and their corresponding signs.

### SUMMARY OF THE INVENTION

The present invention provides, system for instruction of a sign language, the system comprising a display device configured to display video depicting an object, and display information relating to a sign language sign associated with the object.

A user using the display device may thus view both video depicting an object and information relating to a sign language sign associated with the object. The user may thus develop an association between the object and the sign language sign. For example, the video depicting the object could be an animation of the object. More preferably, the video could be an interactive three-dimensional rendering of the object. Displaying video depicting an object may advantageously aid a user’s understanding of the nature of the object associated with the sign language sign, without resorting to written descriptions of the object, such as sub-titles. For example, consider where the object which is the subject of the sign-language sign is a ball. From a static image the user may have difficulty ascertaining whether the object is a table-tennis ball or a football, and consequently the user may form an inaccurate, or at least imprecise, association between the object and the sign language sign. Accordingly, displaying video depicting the object may advantageously improve a user’s ability to learn a sign-language.

The information relating to the sign language sign is information to assist a user with understanding how to articulate the sign language sign. For example, the information could be written instructions defining the articulation, or a static image of a person forming the required articulation. Advantageously, the information could be a video showing the sign language sign being signed. This may best aid a user to understand how to sign the sign language sign

The display device may be configured to display the video depicting the object before or simultaneously with the information relating to the sign language sign. This may advantageously allow user to better understand what the object is before learning the sign language sign. In particular, this may improve user’s correct recollection of sign. For example, the video depicting the object could be displayed immediately before information relating to the sign language sign

The display device may be configured to display at a first time the video depicting the object at a first size and the information relating to the sign language sign at a second, smaller, size, and to display at a second time the information relating to the sign language sign at a size greater than the second size. For example, the video depicting the object could initially be displayed across the full screen, whilst the information relating to the sign language sign could be displayed as a ‘thumbnail’ over the video depicting the object. This order of display best allow a user to firstly understand the nature of the object, and secondly understand how to sign the sign.

The display device may be further configured to display at the second time the video depicting the object at a size less than the first size. For example, the video depicting the object could be displayed as a thumbnail over the information relating to the sign. This may advantageously allow a user to refresh his understanding of the nature of the object whilst learning the sign language sign.

The display device may comprise a human-machine-interface (HMI) device receptive to a user input, wherein the display device is configured to display the information relating to the sign language sign at a size greater than the second size in response to a user input via the human, machine interface device. For example, the HMI device could be a touch-sensitive display response to a user touching an icon displayed on the display. The user may thus choose when the change the display.

The information may comprise a video depicting the sign language sign associated with the object. For example, the video could be a cartoon animation of a character signing the sign language sign. A video may best instruct the user on how to sign the sign, for example, because the video may show dynamically how the hand articulations develop.

The video depicting the sign language sign associated with the object may comprise video of a human signing the sign language sign. Video of a human signing the sign language sign may best assist a user with understanding the manual articulations. Consequently, the best user association of a sign with and object, and best user signing action may be achieved.

The display device may comprises an imaging device for imaging printed graphics. In other words, the display device may comprise a camera. For example, the camera could be a charge-coupled^{..} device (CCD) video camera.

The system may be configured to, in response to an imaging event in which the imaging device is used to image printed graphics depicting an object, analyse image data from the imaging event to identify characteristics of the image data, compare the identified characteristics of the image data to image data characteristics stored in memory and indexed to video depicting objects and to information relating to sign language signs associated with objects, retrieve for display video depicting objects and information relating to sign language signs associated with objects that is indexed to the image data characteristics, and display the retrieved video depicting objects and information relating to sign language signs associated with objects.

In other words, the system may seek to identify an object in an image, or more particularly to identify an association between characteristics of an image of an object with an object. By making such an identification the system may then display video depicting the relevant object and information relating to a sign language sign associated with that object.

The display device may be configured to display the video depicting the object overlaid onto image data from the imaging event. This may advantageously provide an immersive display which may best engage and retain a user’s attention.

The display device may be configured to display the overlaid video depicting the object such that the video appears anchored to a position of the image data corresponding to the printed graphics. This may advantageously provide an immersive display which may best engage and retain a user’s attention.

The video depicting the object may correspond to a three-dimensional model depicting the object, the electronic device may comprise an accelerometer for detecting an orientation of the electronic device, and the electronic device may be configured to vary the displayed video in dependence on the orientation of the electronic device. This may advantageously provide an immersive display which may best engage and retain a user’s attention.

The display device may be configured to display the overlaid video depicting the object such that the video appears anchored to a position of the image data corresponding to the printed graphics in a first mode of operation, and display the overlaid video depicting the object such that the video appears not anchored to any position of the image data in a second mode of operation.

The display device may comprise an accelerometer for detecting the orientation of the display device, and the display device may be configured to operate in the first mode of operation in a first orientation of the display device and in a second mode of operation in a second orientation of the display device.

The display device may comprise a human-machine-interface device receptive to a user input, and the display device may be configured to operate in the second mode of operation in response to a user input via the human-machine-interface device.

The display device may be adapted to be hand-held. Alternatively, the display device could be adapted to be wearable. For example, the display device could be adapted to be worn on a user’s head in the manner of spectacles, or worn on a user’s wrist, like a wrist-watch.

The system may further comprise a substrate having printed thereon a free-hand monochrome illustration depicting an object for imaging by the imaging device. For example, the illustration could be imaged from a free-hand illustration drawn on paper, and the image could then be printed onto the substrate using a computer-controlled printer. The substrate could, for example, be paper, card or fabric. The substrates having the illustrations printed thereon may thus serve as ‘triggers’ for the system, such that the electronic device may image the illustration on the substrate, and in response the device may display the video relating to the illustrated object and sign language information relating to the sign associated with that object.

The system may comprise a plurality of substrates, each substrate having printed thereon a free-hand monochrome illustration depicting an object for imaging by the imaging device, wherein the illustrations printed on the plurality of substrates depict mutually different objects. The plurality of substrates may thus be used to trigger object video and sign language information relating to plural objects.

The invention also provides a computer-implemented method for instruction of a sign language, comprising: displaying video depicting an object, and displaying information relating to a sign language sign associated with the object.

The video depicting the object may be displayed before or simultaneously with the information relating to the sign language sign.

The method may comprise displaying at a first time the video depicting the object at a first size and the information relating to the sign language sign at a second, smaller, size, and displaying at a second time the information relating to the sign language sign at a size greater than the second size.

The method may comprise displaying at the second time the video depicting the object at a size less than the first size.

The method may comprise displaying the information relating to the sign language sign at a size greater than the second size in response to a user input via a human-machine interface device.

The information may comprise video depicting the sign language sign associated with the object.

The video depicting the sign language sign associated with the object may comprise video of a human signing the sign language sign.

The display device may comprise an imaging device for imaging printed graphics.

The method may comprise, in response to an imaging event in which the imaging device is used to image printed graphics depicting an object, analysing image data from the imaging event to identify characteristics of the image data, comparing the identified characteristics of the image data to image data characteristics stored in memory and indexed to video depicting objects and to information relating to sign language signs associated with objects, retrieving for display video depicting objects and information relating to sign language signs associated with objects that is indexed to the image data characteristics, and displaying the retrieved video depicting objects and information relating to sign language signs associated with objects.

The method may comprise displaying the video depicting the object overlaid onto image data from the imaging event.

The method may comprise displaying the overlaid video depicting the object anchored to a position of the image data corresponding to the printed graphics.

The video depicting the object may correspond to a three-dimensional model depicting the object, and the method may comprise varying the displayed video in dependence on the orientation of the electronic device.

The method may comprise displaying the overlaid video depicting the object anchored to a position of the image data corresponding to the printed graphics in a first mode of operation, and displaying the overlaid video depicting the object not anchored to any position of the image data in a second mode of operation.

The method may comprise detecting an orientation of the display device, operating the display device in a first mode of operation in a first orientation of the display device and operating the display device in a second mode of operation in a second orientation of the display device.

The method may comprise operating the display in the second mode of operation in response to a user input via a human-machine-interface device.

The present invention also provides a computer program comprising instructions which, when the program is executed by a computer, cause the computer to carry out a method of any one of the preceding statements.

The present invention also provides a computer-readable data carrier comprising instructions which, when executed by a computer, cause the computer to carry out a method of any one of the preceding statements.

A further aspect of the invention relates to an augmented reality system.

Augmented reality is an interactive experience of a real-world environment enhanced by computer-generated perceptual information. Augmented reality is used to enhance natural environments or situations and offer perceptually enriched experiences.

The present invention provides an augmented reality system comprising: a substrate having printed thereon a free-hand monochrome illustration, a computing device having stored in memory data defining characteristics of the illustration indexed to video data, wherein the computing device is configured to receive image data, analyse the image data to identify characteristics of the image data, compare the identified characteristics of the image data to the characteristics of the illustration stored in the memory, and determine whether a match exists between the identified characteristics of the image data and the characteristics of the illustration.

Free-hand monochrome illustrations have been found to advantageously provide a good ‘signature’ for identification of an object by a computer-implemented image analysis technique. It is postulated that this is a result of the inherently high degree of randomisation of features of a free-hand illustration. Additionally, it has been found that monochrome illustrations provide a high degree of colour contrast between features of the illustration, which similarly has been found to improve object identification in a computer-implemented image analysis technique. Accordingly, using free-hand illustration may advantageously improve identification of image characteristics. For example, the illustration could be imaged from a free-hand illustration drawn on paper, and the image could then be printed onto the substrate using a computer-controlled printer. The substrate could, for example, be paper, card or fabric. The substrates having the illustrations printed thereon may thus serve as ‘triggers’ for the system, such that the electronic device may image the illustration on the substrate, and in response the device may display the video relating to the illustrated object and sign language information relating to the sign associated with that object.

The computing device may be configured to, in response to a determination that a match exists between the identified characteristics of the image data and the characteristics of the illustration, retrieve for display video data that is indexed to the characteristics of the illustration.

The computing device may be configured to, in response to a determination that a match exists between the identified characteristics of the image data and the characteristics of the illustration, communicate video data that is indexed to the characteristics of the illustration to an electronic display device in communication with the computing device.

The system may comprise further substrates having printed thereon further free-hand monochrome illustrations, wherein the computing device comprises stored in memory data defining characteristics of the further illustrations indexed to further video data, and wherein computing device is configured to compare the identified characteristics of the image data to the data defining characteristics of the further illustrations.

The system may comprise an electronic display device in communication with the computing device, wherein the computing device is configured to, in response to a determination that a match exists between the identified characteristics of the image data and the characteristics of the illustration, communicate the video data indexed to the characteristics of the illustration to the electronic display device for display.

The electronic display device may be configured to display the video data transmitted by the computing device.

The electronic display device may comprise an imaging device for imaging the illustration printed on the substrate during an imaging event.

The electronic display device may be configured to, in response to an imaging event in which the imaging device is used to image the illustration, communicate image data from the imaging event to the computing device.

The electronic display device may be adapted to communicate with the computing device via wireless data transmission. The electronic display device may thus be located at a position remote from the computing device.

The electronic display device may be configured to be hand-held. Alternatively, the display device could be adapted to be wearable, For example, the display device could be adapted to be worn on a user’s head in the manner of spectacles, or worn on a user’s wrist, like a wrist-watch.

The electronic display device may be configured to display the video data overlaid onto image data from the imaging event.

The electronic display device may be configured to display the overlaid video data such that the video data appears anchored to a position of the image data corresponding to the illustration printed on the substrate.

The video data may represent a three-dimensional model of an object, the electronic display device may comprise an accelerometer for detecting an orientation of the electronic display device, and the electronic display device may be configured to vary the displayed video in dependence on the orientation of the electronic display device.

The electronic display device may be configured to display the overlaid video data such that the video appears anchored to a position of the image data corresponding to the illustration printed on the substrate in a first mode of operation, and display the overlaid video data such that the video appears not anchored to any position of the image data in a second mode of operation.

The electronic display device may comprise an accelerometer for detecting the orientation of the electronic display device, and the electronic display device may be configured to operate in the first mode of operation in a first orientation of the electronic display device and in the second mode of operation in a second orientation of the electronic display device.

The electronic display device may comprise a human-machine-interface device receptive to a user input, and the electronic display device may be configured to operate in the second mode of operation in response to a user input via the human-machine-interface device.

The substrate may be a fabric.

The fabric may comprise at least a majority of cotton fibres.

The fabric may comprise a mix of cotton and synthetic fibres, Synthetic fibre additions may advantageously improve the print resolution of graphics printed on the fabric.

The fabric may comprise ringspun cotton having a weight of at least 180 grams per square metre

The substrate may comprise fabric laminated to paper. Laminating fabrics to paper may advantageously the flatness of the printing surface and thereby minimise distortion of the graphic resulting from creasing of the fabric.

The fabric may be configured as a wearable garment.

A further aspect of the invention relates to generating a computer model of an object for an augmented reality system.

Augmented reality animations are usually originated within computer software. They may thus undesirably have a distinctively ‘computer-generated’ aesthetic.

The invention provides a method of generating a computer model of an object for an augmented reality system, comprising: generating using a computer a three-dimensional model of an object, the three-dimensional model comprising a plurality of constituent three-dimensional blocks, identifying surfaces of the constituent three-dimensional blocks that define a visible surface of the three-dimensional model, printing onto a substrate a representation of the surfaces of the three-dimensional blocks identified as defining a visible surface of the three-dimensional model, hand-illustrating onto the substrate over the representations of the surfaces, imaging the substrate following hand-illustration to create image data in a machine-readable format, uploading the image data to a computer, and mapping the image data onto the three-dimensional model using the computer such that image data depicting the hand-illustrated surfaces is assigned to its corresponding position on the visible surface of the three-dimensional model.

The method thus advantageously provides a method for generating a three-dimensional model, suitable for rendering in an augmented reality application, where the model comprises hand-illustration. Hand-illustration may provide a more desirable aesthetic. Furthermore, it may be desirable to a use a hand-illustration as a trigger point for an augmented reality application, for the reason that the hand-illustration may be more accurately identified by a computer implemented image analysis technique. Accordingly, it may be desirable that the three... dimensional model is correspondingly hand-illustrated to provide visual cohesion between the trigger illustration and the model.

The method may comprise generating a view of the three-dimensional model following mapping of the image data onto the three-dimensional model, and creating on a further substrate a hand-illustration of the view. The hand-illustration of the view may be used a trigger image for an augmented reality application. Hand-illustrating the trigger image based on the illustrated model may improve visual cohesion between the trigger image and the model.

The method may comprise imaging the further substrate following hand-illustration to create further image data in a machine-readable format, uploading the further image data to a computer, identifying characteristics of the further image data, and storing in memory of the computer the identified characteristics of the further image data indexed to the three dimensional model. The trigger image may thus be indexed to the three-dimensional model such that the model may be displayed in response to imaging of the trigger image.

### BRIEF DESCRIPTION OF THE DRAWINGS

In order that the present invention may be more readily understood, embodiments of the invention will now be described, by way of example, with reference to the accompanying drawings, in which

FIG. 1 shows schematically a system for instruction of sign language embodying an aspect of the present invention;

FIG. 2 shows a hand held electronic device of the system being used to image a graphical representation of an object printed on a substrate;

FIG. 3 shows the hand held electronic device being used in a first mode operation to display video depicting the object graphically represented on the substrate;

FIG. 4 shows the hand held electronic device being used in a second mode of operation to display video depicting the object graphically represented on the substrate;

FIG. 5 shows the hand held electronic device being used to display video relating to a sign language sign associated with the object;

FIG. 6 shows a substrate embodying an aspect of the present invention having graphics printed thereon;

FIG. 7 is a block diagram showing schematically stages of a process for displaying video depicting an object and information relating to a sign language sign associated with the object in response to imaging of printed graphics depicting an object;

FIG. 8 is a block diagram showing schematically stages of a process for analysing an image to identify image characteristics;

FIG. 9 shows schematically a computer-implemented technique for analysing an image to identify image characteristics;

FIG. 10 shows schematically a computer-implemented technique for comparing identified image characteristics to reference image characteristics;

FIG. 11 shows schematically a computer-generated three-dimensional model of an object;

FIG. 12 shows schematically representations of the surfaces of the three-dimensional model shown in FIG. 11 printed on a substrate;

FIG. 13 shows hand illustration applied onto the substrate over the representations of the surfaces of the model; and

FIG. 14 shows image data of the illustrated substrate mapped onto the three-dimensional model.

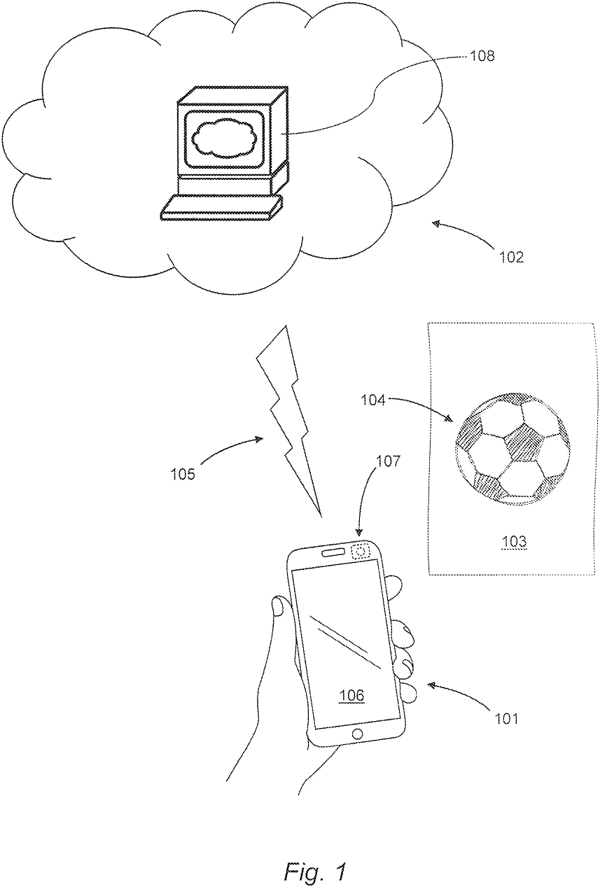

### DETAILED DESCRIPTION OF THE INVENTION

A system for instruction of sign language comprises a hand-held electronic device 101, backend computing system 102, and a substrate 103 having printed thereon graphics 104 depicting an object, in the example, a football.

Hand-held electronic device 101 is a cellular telephone handset having a transceiver for communicating wirelessly with remote devices via a cellular network, for example, via a wireless network utilising the Long-Term-Evolution (LTE) telecommunications standard . Handset 101 comprises a liquid-crystal display screen 106 visible on a front of the handset, and further comprises an imaging device 107 for optical imaging, for example, a CCD image sensor, on a rear of the handset for imaging a region behind the handset. In the example, the screen 106 is configured to be ‘touch-sensitive’, for example, as a capacitive touch screen, so as to be receptive to a user input and thereby function as a human-machine-interface between application software operating on the handset 101 and a user. The handset 101 comprises computer processing functionality and is capable of running application software. As will be described, the handset 101 is configured to run application software, stored in an internal memory of the handset, for the instruction of a sign language, for example, for the instruction of British Sign Language. It will be appreciated by the person skilled in the art, that for the purpose of the present invention, the handset 101 may be a conventional ‘smartphone’ handset, which will typically comprise all the necessary capabilities to implement the invention.

Backend computing system 102 is configured as a ‘cloud’ based computing system, and comprises a computing device 108 located remotely from the handset 101 in communication with the handset 101 via the wireless network 105. For example, the wireless network 105 could be an LTE compliant wireless network in which signals are transmitted between the computing device 108 and the handset 101 via intermediate wireless transceivers

Substrate 103, in this example, is a sheet of paper having the graphics 104 printed on a surface of the paper, for example, using an inkjet printer. The graphic 104 is a representation of a free-hand illustration of a football.

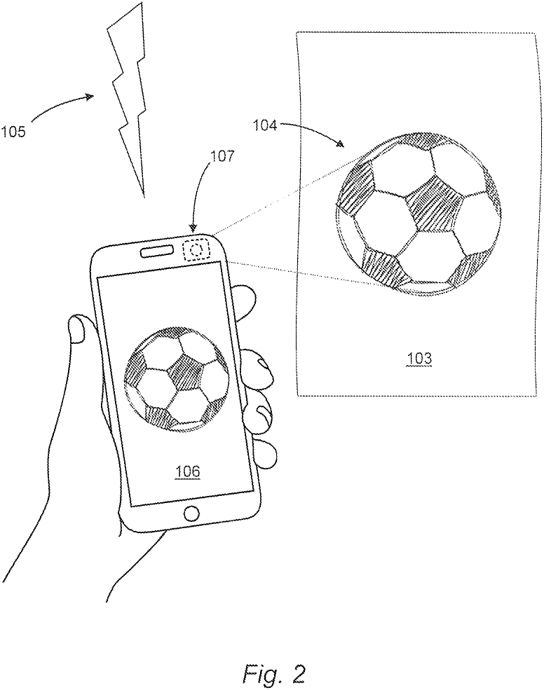

Referring in particular to FIG. 2, handset 101 is operated to run application software, which causes the imaging device 107 of the handset 101 to continuously image a region behind the handset. Handset 101 may thus be located in front of substrate 103 to thereby image the graphic 104 printed on the substrate 103. Handset 101 is configured to transmit image data in real time to the backend computing system 102 via the wireless network 105 for processing by the computing device 108.

The backend computing system 102 is configured to receive the image data and process the image data to detect characteristics of the imagery. As will be described in detail with reference to later Figures, the backend computing system 102 is configured to analyse the received image data to detect whether a graphic depicting an object corresponding to a predefined object data set stored in memory of the computing device 108 is being imaged. In the example of FIG. 2, the backend computing system 102 analyses the graphic 104 depicting a football printed on substrate 103, and matches this to image to video data depicting a football and to video data relating to a sign language sign associated with a football, that is stored in memory of the computing device 108. In response to the match, the backend computing system 102 is configured to transit the video data depicting a football and the video data relating to a sign language sign associated with a football to the handset 101 via the wireless network 105.

As an alternative to backend computing system 102 for processing of image data captured by the imaging device 107 of the handset 101, the handset could comprise on-board image processing functionality for processing the image, thus negating the requirement to transmit image data to the backend computing system. This may advantageously reduce latency in processing of the image, for example resulting from delays in transmission, but disadvantageously may increase the cost, complexity, mass, and/or power-consumption of the handset 101.

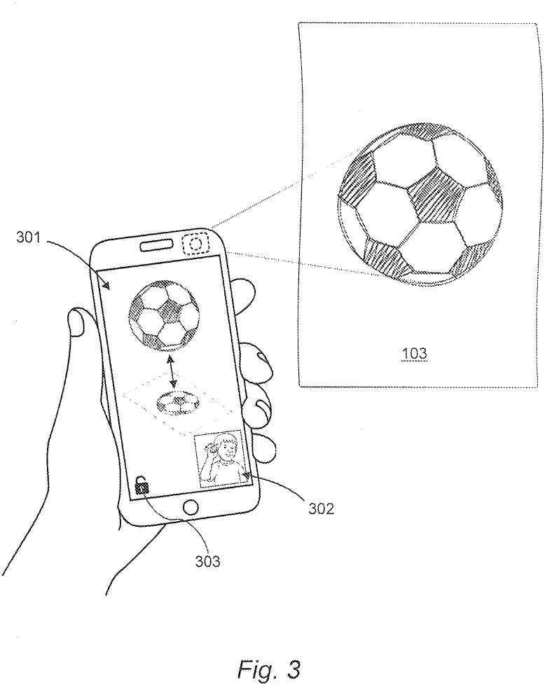

Referring next in particular to FIG. 3, the handset 101 is configured to display the received video depicting the football and also display the video depicting the sign language sign associated with a football on the screen 106 simultaneously on regions 301, 302 of the screen respectively. Display video depicting the object which is the subject of the sign language sign may advantageously aid understanding of the nature of the object to be signed by the user. In the example, the video depicting the object is an animation of a football bouncing up and down on real-time video imagery of the substrate 103. In the example, the video depicting the object thus takes the form of ‘augmented reality’ imagery, in which video data depicting a football that is received from the backend computing system 102 is overlaid onto real-time imagery imaged by the imaging device 107 of the handset 101. Augmented reality imagery of this type may be particularly effective in aiding a user’s understanding of an object to be signed.

Referring still to FIG. 3, the system is configured to firstly display on the screen 106 the video depicting the object, in the example a football bouncing up and down, on a large area of the screen 301, i.e. in a ‘fullscreen’ mode, and to display the video relating to the sign language sign on a smaller area of the screen 302, i.e. as a ‘thumbnail’. This configuration may best allow a user to understand the nature of the object depicted in the video, whilst also providing a preview of the sign language sign associated with the object to be signed.

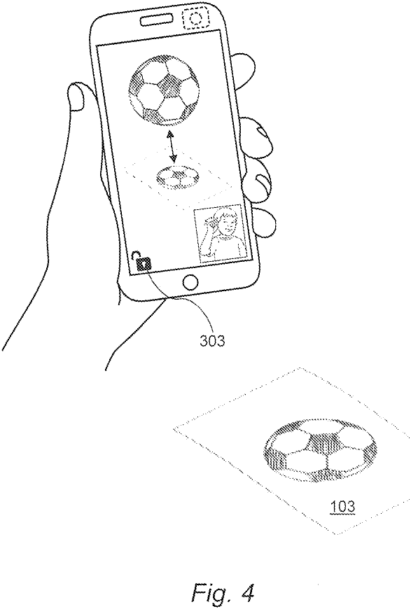

The application software running on handset 101 allows for switching between ‘anchored’ and ‘non-anchored’ modes of viewing the videos. In a first, ‘anchored’, mode of operation, depicted in FIG. 3, the video data depicting the object football is overlaid onto real-time imagery captured by the imaging device 107 of the handset 101 in a way that the video data depicting the object football remains positionally locked relative to the position of the imagery of the graphic 104 on the substrate 103. Thus, in this mode of operation the positions of the video depicting the object, e.g. the bouncing football, and the real-time imagery of the graphic printed on the substrate adapt relative to the area of screen to accommodate for movement of the handset 101. This may provide a realistic visual which may best engage the user’s interest and attention. In a second, ‘non-anchored’ mode of operation, depicted in FIG. 4, a static snapshot from imagery of the graphic printed on the substrate may be displayed on the screen 106 over which the video depicting the object, i.e. the bouncing ball, is overlaid. Thus, in this mode of operation the user is not required to continuously point the imaging device 107 of the handset 101 at the graphic 104 printed on the substrate 103, rather the user may hold the handset in any desired position whilst the video depicting the object and the imagery of the printed graphic remain visible. This second mode of operation may allow a user to relax and move positions whilst maintaining use of the application software to view the object video and the image of the printed graphic. For the purpose of controlling the mode of operation the application software presents an icon 303 on the screen 106. In response to a user touching the icon 303 the application software is configured to switch between the anchored and non-anchored modes of operation of FIGS. 3 and 4 respectively.

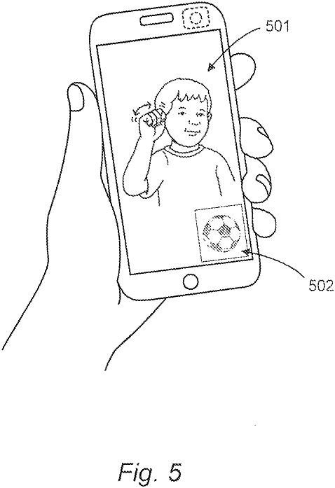

Referring next in particular to FIG. 5, the application software running on the handset 101 is configured, after firstly displaying the video depicting the object in ‘fullscreen’ mode, as illustrated in FIGS. 3 and 4, to change the display such that secondly the video relating to the sign language sign is displayed on a large area of the screen 501, i.e. in ‘fullscreen’, and the video depicting the object is displayed on a small area of the screen 502, i.e. as a ‘thumbnail’. In this order of display, a user having first seen the video depicting the object, and thus hopefully having fully understood the nature of the object, may subsequently view and learn the sign language sign associated with the object. Maintaining the video depicting the object as a thumbnail may usefully serve as an aide memoire to the user as to the nature of the object associated with the sign language sign.

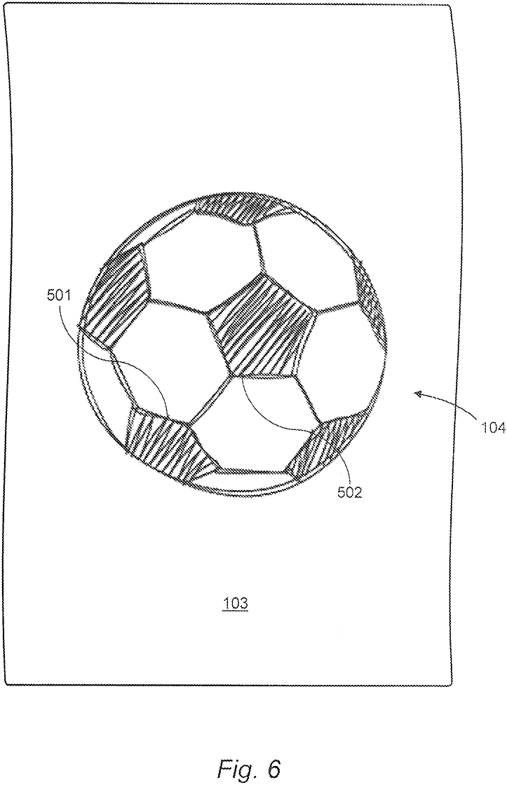

Referring in particular to FIG. 6, the graphic 104 printed on the substrate 103 is a monochrome representation of a free-hand illustration of an object, in the example, a football. Thus, for example, the process of producing the printed substrate may comprise firstly creating a free-hand illustration of the object football, uploading a scan of the free-hand illustration to a computer running a printer control program, and using the computer to control a printer, for example, a lithographic printer, to apply an ink to the substrate 103. The process could optionally comprise an intermediate image editing process implemented on the computer where the scanned image of the illustration could be edited, for example, to add additional features or to delete features of the illustration from the image.

It has been observed that a free-hand illustration provides a particularly effective means of representing an object to be imaged by the imaging device. This is thought to be because of the natural variability in features of the illustration that result from free-hand illustration. Referring in this regard still to FIG. 6, it will be noted that the free-hand illustration of the football comprises a large number of different line features, such as edges 501, 502, each of which features may serve as a reference point in an ‘automated’ computer-implemented process of feature detection, for example, in an edge detection technique. This relatively great number of potential image reference features advantageously increases the identifiable variations between illustrations of different objects, thereby reducing the risk of mis-identification of an object by the system.

In contrast, illustrations created using a computer in a line vector format, where each point of the illustration is defined by common co-ordinates and relationships between points by a line and curve definitions from a finite array of possible definitions, tend to exhibit lesser variation between illustrations of different objects. It has been observed that this undesirably increases the risk of mis-identification of an object by the system.

Moreover, it has been found that the illustrations should preferably be presented in monochrome. Monochrome colouring provides a maximal contrast between line features of the illustration. This has been found to advantageously improve feature detection in a computer implemented feature analysis technique, for example, an edge detection technique. This reduces the risk of mis-identification of the illustration by the system.

In the specific example, the substrate 103 is paper. Paper advantageously provides a desirably flat and uniform structure for graphics 104, which may improve imaging of the graphics by the imaging device 107. However, the graphics 104 could be printed onto an alternative substrate, for example, onto a fabric. This may be desirable, for example, where the graphic is to be printed onto an item of clothing, for example, onto a shirt.

Certain difficulties have been observed however in printing graphics onto fabric for the purpose of using the graphics in a computer-implemented image analysis technique. In particular, it has been observed that with certain fabrics, for example, coarsely woven cotton such as hessian, image resolution is lost when the graphics are printed onto the fabric due to the large spacing between threads. Problems associated with lost resolution are particularly exacerbated for graphics having relatively small dimensions. Preferred fabrics for this application are cotton, silk, bamboo and linen. Types of suitable cotton include: Poplin cotton, ringspun cotton, combed cotton and cotton flannel.

A preferred fabric for the application is ringspun cotton-style weave having a weight of 100 grams per square-metre, or greater, preferably at least 150 grams per square-metre, and even more preferably at least 180 per square-metre.

A number of particularly suitable fabric and printing techniques have been identified, including: (1) Muslin cloth comprising 100% cotton and having a minimum weight of 100 grams per square-metre, where graphics are printed onto the fabric using screen-printing or direct-to-garment techniques, with a graphic size of at least 5 square-centimetres; (2) Ringspun cotton comprising 100% cotton having a minimum weight of 180 grams per square-metre, where graphics are printed using screen-printing with a minimum graphic size of 4 square-centimetre, or direct-to-garment techniques with a minimum graphics size of 2 square-centimetre: (3) Heavyweight cotton, having a weight of at least 170 grams per square-metre, graphics printed using a screen printing technique with a minimum graphic size of 4 square-centimetres, or printed using a direct-to-garment technique with a minimum graphic size of 2 square-centimetres: (4) Denim, having a weight of at least 220 grams per square-metre, graphics printed using a screen printing technique with a minimum graphic size of 5 square-centimetres, or printed using a direct-to-garment technique with a minimum graphic size of 3 square-centimetres: and (5) Curtain, having a weight in the range of 250 grams per square-metre to 300 grams per square-metre, graphics printed using a screen printing technique with a minimum graphic size of 5 square-centimetres, or printed using a direct-to-garment technique with a minimum graphic size of 3 square-centimetres.

Suitable fabrics may comprise cotton and synthetic fibre mixes, for example, polyester synthetic fibres in a 60% cotton, 40% polyester mix, or acrylic synthetic fibres in a 70% cotton, 30% polyester mix. It has been observed in this respect that synthetic fibre additions may improve the print resolution for printed graphics. Further cotton-synthetic mixes that have been observed to form a suitable substrate for printing of the graphics, including Spandex, Elastane and Lycra, although for these fibres a relatively greater percentage of cotton should be used in the mix, for example, a 90% cotton, 10% synthetic fibre mix.

Fabrics laminated to paper, for example, bookbinding cloth, have additionally been observed to form suitable substrates for printing of the graphics. It has been observed in this regard that laminating fabrics to paper improves the flatness of the printing surface of the material, thereby reducing distortion of the graphic resulting from creasing of the fabric. Suitable print techniques for printing onto laminated fabric include screen-printing, offset litho-printing, and direct-to-garment printing. A preferred minimum graphic size for offset-printing onto fabric laminated to paper is 5 square-centimeter. Foil stamping is a further known suitable printing technique for printing graphics onto fabrics laminated to paper, in which technique lines of graphics should be at least 1 millimetre in width, a graphics should have a minimum size of 5 square-centimetres.

Where graphics are screen-printed onto fabric, it has been observed that a silkscreen printing weave of at least 120 thread per centimetre (T) should ideally be used. Larger images may however be acceptably printed using a silkscreen printing weave with a lower thread count, although the thread count should ideally be at least 77T.

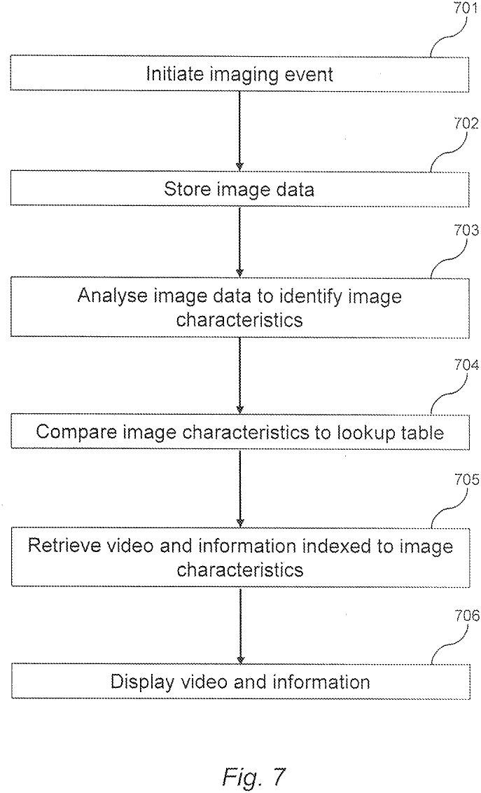

Referring to FIG. 7, a process for imaging a graphic depicting an object printed on a substrate and displaying video depicting that object and sign language information relating to a sign associated with the object is shown.

At step 701 an imaging event is initiated, whereby the imaging device 107 of the handset 101 begins to image its field of view. The imaging event could for example be initiated automatically by the application software.

At step 702 image data captured by the imaging device 107 of the handset 101 is stored in computer readable memory. In the specific example, where image analysis and comparison is performed by a computing device 108 located remotely from the handset 101, the step of storing the image data is preceded by an intermediate step of firstly transmitting the image data from the handset to the backend computing system 102 for storage on memory of the computing device 108. In an alternative implementation however, image analysis and comparison could be performed locally on the handset 101, in which case storing the image date could comprise storing the image data on local memory of the handset 101.

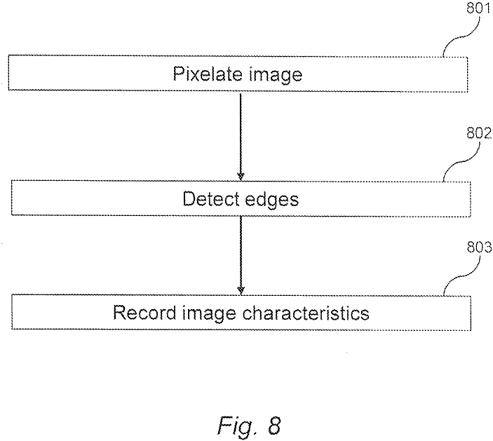

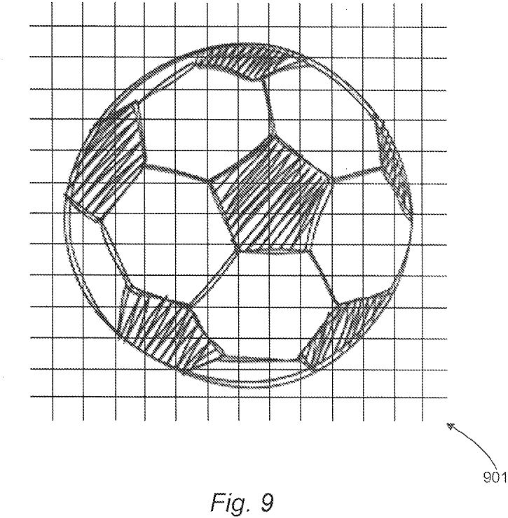

At step 703 a computer implemented image analysis process is implemented to identify characteristics of the stored imagery. Data defining image characteristics may then be stored in memory of the computing device undertaking the image analysis, in this exampie in the memory of the remote computing device 108. The image analysis process is described in further detail with reference to FIGS. 8 and 9.

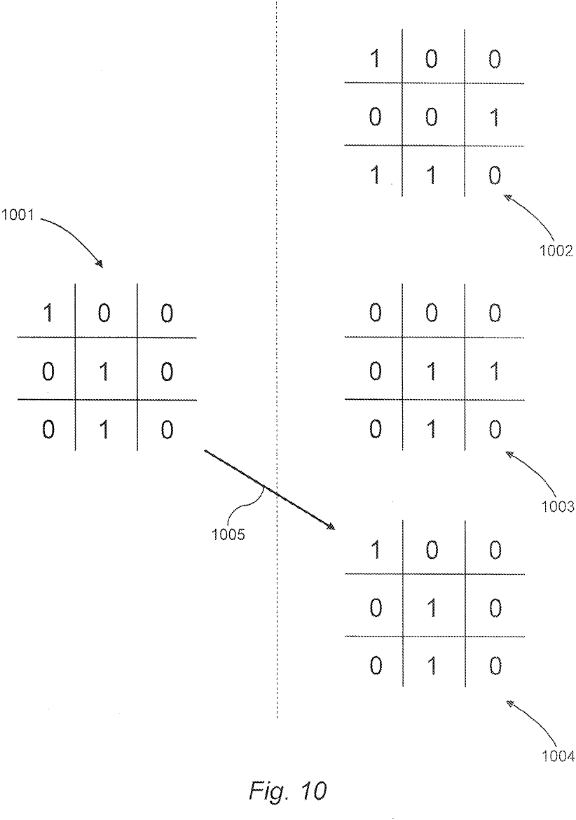

At step 704 a computer implemented image comparison process is implemented, whereby the identified characteristics of the captured imagery are compared to data sets stored in memory of the computing device 108, which data sets are indexed to video files depicting an object corresponding to the identified image characteristics and to video files relating to a sign language sign associated with the corresponding object. The image comparison process is described in further detail with reference to FIG. 10.

At step 705 the video files depicting an object corresponding to the identified image characteristics and video files relating to a sign language sign associated with the corresponding object are retrieved from memory of the computing device 108, and transmitted using the wireless network 105 to the handset 101.

At step 706 the retrieved video files are displayed on the screen 106 of the handset 101 in accordance with the implementation described with reference to FIGS. 3 to 5.

Procedures of the image analysis step 703 are shown schematically in FIG. 8 In a first step 801 the imagery imaged by the imaging device 107 of the handset 101 is pixelated, such that the image is represented by an array of discrete pixels having colour characteristics corresponding to the colouring of the original image. A simplified image pixelation technique is shown in FIG. 9, whereby the captured imagery is divided into an array 901 of pixels.

At step 802 a conventional edge detection process is implemented by the computing device 108 The edge detection process may address each pixel of the array in turn. For example, the edge detection process could assign a value to each pixel in dependence on the colour contrast between the pixel and a neighbouring pixel This measure of colour contrast may be used as a proxy for detection of a boundary of a line feature of the illustration. The result would thus be an array of values corresponding in size to the number of pixels forming the pixelated image.

At step 803 the detected image characteristics are stored in memory of the computing device 108.

A simplification of the image comparison step 704 is shown schematically in FIG. 10. Referring to the Figure, a data set 1001 defining characteristics of the captured image is retrieved from memory of the computing device 108. In the example, the data set comprises a 3x3 array, and thus defines a 9 pixel image. In the simplified example, each pixel of the array is assigned a value of either 0 or 1 in dependence on the degree of colour contrast between the pixel and an immediately adjacent pixel. For example, where the colour contrast exceeds a threshold a value of 1 is assigned, whereas where the colour contrast is less than a threshold a value of 0 is assigned. Thus, the dataset defining the image characteristics may be compared to datasets 1002, 1003, 1004 stored in memory of the computing device 108 that are indexed to video depicting an object and video relating to a sign language sign associated with the object. Where a match 1005 in the datasets is identified, it may be inferred that the captured image is of a particular object, and video indexed to the dataset 1004, and information relating to a sign language sign indexed to dataset 1004, may be retrieved for display.

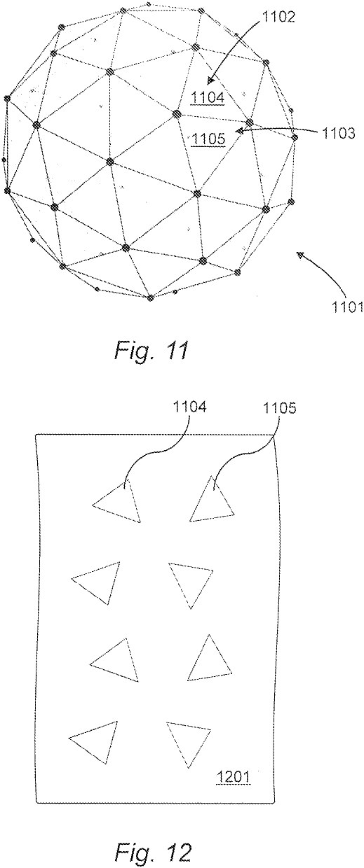

Processes relating to a method of generating a computer model for an augmented reality system as shown in FIGS. 11 to 14.

The method involves a first step of generating using a computer a three-dimensional model 1101 of an object, in the example a football, comprised of a plurality of constituent three-dimensional blocks, such as blocks 1102, 1103. In the example, the model 1101 is defined by a plurality of polygons. The model is analysed to identify surfaces of the blocks that define a visible surface of the three-dimensional model, such as surfaces 1104 and 1105.

Referring in particular to FIG. 12, representations 1201 of the shapes of the visible surfaces of the blocks of the model 1101 are then printed, for example, using a computer-controlled printer, onto a substrate 1201, for example, onto paper or fabric.

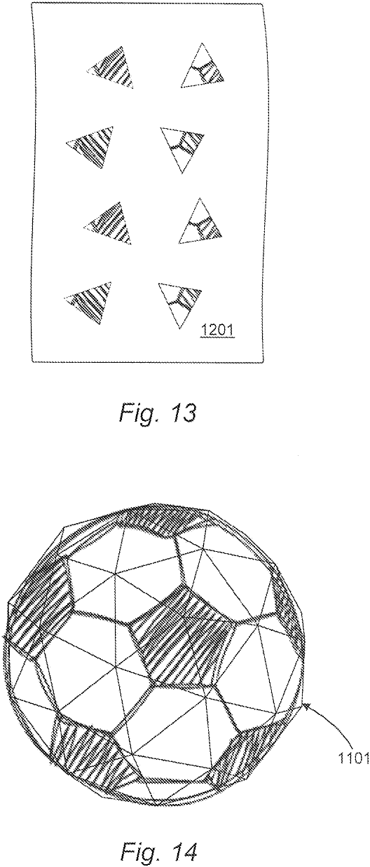

Referring next in particular to FIG. 13, the method then involves hand-illustrating onto the substrate 1201 over the representations of the visible surfaces of the blocks with desired graphics, in the example, graphics depicting surface markings of a football.

Referring next to FIG. 14, following an intermediate step of imaging the illustrated substrate 1201 and uploading the image data to a computer, the method involves mapping the image data on to the three-dimensional model 1101, such that image date depicting the hand-illustrated surfaces of the blocks is assigned to its corresponding position on the visible surface of the model.

1. A system for instruction of a sign language, the system comprising a display device configured to:
display video depicting an object, and
display information relating to a sign language sign associated with the object, wherein the object is a subject of the sign-language sign.

2. A system as claimed in claim 1, wherein the display device is configured to display the video depicting the object before or simultaneously with the information relating to the sign language sign.

3. A system as claimed in claim 1, wherein the display device is configured to display at a first time the video depicting the object at a first size and the information relating to the sign language sign at a second, smaller, size, and to display at a second time the information relating to the sign language sign at a size greater than the second size.

4. A system as claimed in claim 3, wherein the display device is further configured to display at the second time the video depicting the object at a size less than the first size.

5. A system as claimed in claim 3, wherein the display device comprises a human-machine-interface device receptive to a user input, wherein the display device is configured to display the information relating to the sign language sign at a size greater than the second size in response to a user input via the human-machine interface device.

6. A system as claimed in claim 1, wherein the information comprises video depicting the sign language sign associated with the object.

7. A system as claimed in claim 6, wherein the video depicting the sign language sign associated with the object comprises video of a human signing the sign language sign.

8. A system as claimed in claims 1, wherein the display device comprises an imaging device for imaging printed graphics.

9. A system as claimed in claim 8, configured to, in response to an imaging event in which the imaging device is used to image printed graphics depicting an object, analyse image data from the imaging event to identify characteristics of the image data, compare the identified characteristics of the image data to image data characteristics stored in memory and indexed to video depicting objects and to information relating to sign language signs associated with objects, retrieve for display video depicting objects and information relating to sign language signs associated with objects that is indexed to the image data characteristics, and display the retrieved video depicting objects and information relating to sign language signs associated with objects.

10. A system as claimed in claim 9, wherein the display device is configured to display the video depicting the object overlaid onto image data from the imaging event.

11. A system as claimed in claim 10, wherein the display device is configured to display the overlaid video depicting the object such that the video appears anchored to a position of the image data corresponding to the printed graphics.

12. A system as claimed in claim 9, wherein the video depicting the object corresponds to a three-dimensional model depicting the object, the electronic device comprises an accelerometer for detecting an orientation of the electronic device, and the electronic device is configured to vary the displayed video in dependence on the orientation of the electronic device.

13. A system as claimed in claim 10 wherein the display device is configured to display the overlaid video depicting the object such that the video appears anchored to a position of the image data corresponding to the printed graphics in a first mode of operation, and display the overlaid video depicting the object such that the video appears not anchored to any position of the image data in a second mode of operation.

14. A system as claimed in claim 13, wherein the display device comprises an accelerometer for detecting the orientation of the display device, and the display device is configured to operate in the first mode of operation in a first orientation of the display device and in a second mode of operation in a second orientation of the display device.

15. A system as claimed in claim 13, wherein the display device comprises a human-machine-interface device receptive to a user input, and the display device is configured to operate in the second mode of operation in response to .a user input via the human-machine-interface device.

16. A system as claimed in claim 8, further comprising a substrate having printed thereon a free-hand monochrome illustration depicting an object for imaging by the imaging device.

17. A system as claimed in claim 16, comprising a plurality of substrates, each substrate having printed thereon a free-hand monochrome illustration depicting an object for imaging by the imaging device, wherein the illustrations printed on the plurality of substrates depict mutually different objects.

18. A system as claimed in claim 1, wherein the display device is adapted to be hand-held or wearable.

19. A computer-readable non-transitory data carrier comprising instructions which, when executed by a computer, cause the computer to carry out the method of:
displaying video depicting an object, and
displaying information relating to a sign language sign associated with the object.

20. An augmented reality system comprising:
a substrate having printed thereon a free-hand monochrome illustration,
a computing device having stored in memory data defining characteristics of the illustration indexed to video data,
wherein the computing device is configured to receive image data, analyse the image data to identify characteristics of the image data, compare the identified characteristics of the image data to the characteristics of the illustration stored in the memory, and determine whether a match exists between the identified characteristics of the image data and the characteristics of the illustration.
